(19) United States
(12) Patent Application Publication
(10) Pub. No.: US 2002/0143600 A1
(43) Pub. Date: Oct. 3, 2002

(54) Internet-based appointment scheduling

(76) Inventor: Valerie G. Dugan, Tarrytown, NY (US)

Correspondence Address: VALERIE G. DUGAN, DUGAN & DUGAN, 18 JOHN STREET, TARRYTOWN, NY, 10591, US

(21) Appl. No.: 10/094,542

(22) Filed: Mar. 8, 2002

Related U.S. Application Data
(60) Provisional application No. 60/274,306, filed on Mar. 8, 2001.

(51) Int. Cl. G06F 15/16; G06F 17/60

(52) U.S. Cl. 705/9; 709/204

(57) ABSTRACT

In a first aspect, a server is provided that is adapted to schedule appointments over the INTERNET. The server includes an interface adapted to send and to receive information regarding at least one appointment over the INTERNET; and a processor coupled to the interface, the processor comprising computer program code adapted to schedule at least one appointment in response to information received via the interface. Numerous other embodiments are provided, as are computer program products for carrying out these and other aspects.

This patent application claims priority from U.S. Provisional Patent Application Serial No. 60/274,306, filed Mar. 8, 2001, which is hereby incorporated by reference herein in its entirety.

### FIELD OF THE INVENTION

The present invention relates to appointment scheduling, and more specifically to internet-based appointment scheduling.

### BACKGROUND OF THE INVENTION

Appointment scheduling often involves contacting multiple persons multiple times to agree on appointment date, time and location. Additional efforts also may be required such as reserving a conference room, scheduling a lunch delivery, and the like. Assume, for example, that east coast patent attorney A wishes to meet with west coast inventors C, D and E (who all work in different buildings of the same company). To schedule a meeting with inventors C, D and E, attorney A typically must (1) make multiple telephone calls to each inventor to obtain a mutually agreeable time to meet; (2) arrange for a conference room or other suitable meeting facility; and/or (3) arrange for lunch to be catered. Such a process can be both time consuming and frustrating.

Accordingly, a need exists for methods and apparatus for improving the efficiency of scheduling appointments.

### SUMMARY OF THE INVENTION

In a first aspect of the invention, a server is provided that is adapted to schedule appointments over the INTERNET. The server includes an interface adapted to send and to receive information regarding at least one appointment over the INTERNET; and a processor coupled to the interface, the processor comprising computer program code adapted to schedule at least one appointment in response to information received via the interface.

In a second aspect of the invention, a computer-based method is provided for scheduling an appointment. The computer-based method includes the steps of (1) receiving via the INTERNET a request from a first user to view a schedule of a second user; (2) displaying via the INTERNET the schedule of the second user in response to the request; (3) receiving via the INTERNET a request from the first user to make an appointment with the second user; and (4) notifying the second user of the appointment via the INTERNET. Numerous other embodiments are provided, as are computer program products for carrying out these and other aspects of the invention. Each computer program product may be carried by a medium readable by a computer (e.g., a carrier wave signal, a floppy disc, a hard drive, a random access memory, etc.).

Other objects, features and aspects of the present invention will become more fully apparent from the following detailed description of the preferred embodiments, the appended claims and the accompanying drawings.

### BRIEF DESCRIPTION OF THE DRAWINGS

FIG. 1 illustrates a scheduling system for scheduling appointments via the INTERNET in accordance with the present invention; and

FIG. 2 is an exemplary graphical user interface that may be employed to schedule appointments in accordance with the present invention.

### DETAILED DESCRIPTION

In accordance with the present invention, methods, systems, apparatus and computer program products are provided for scheduling appointments via the INTERNET. As used herein, an appointment may include a meeting, an engagement or the like.

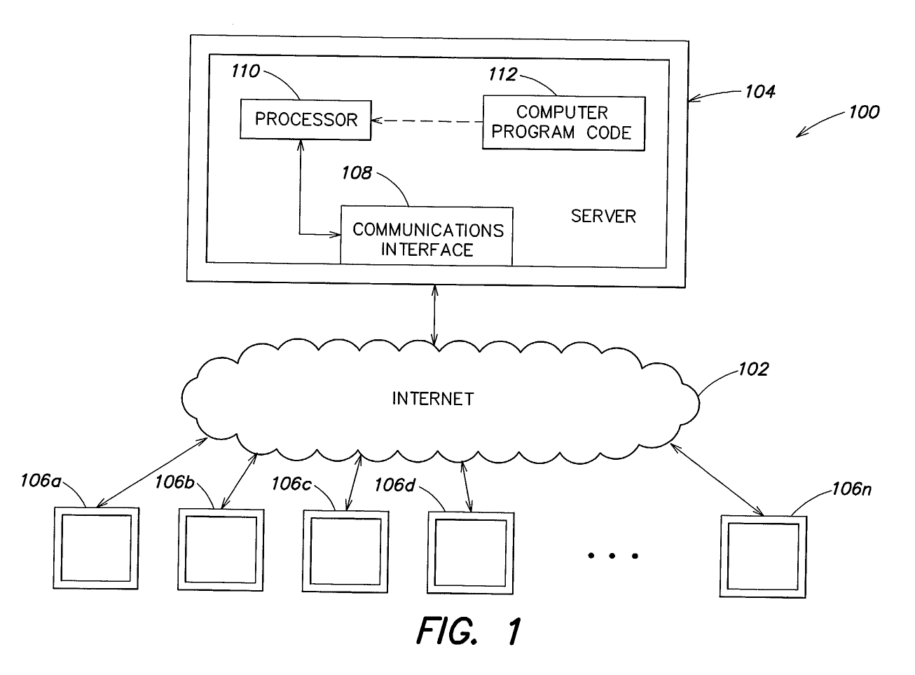

With reference to FIG. 1, a scheduling system 100 for scheduling appointments via the INTERNET (represented by reference numeral 102) is shown. Specifically, the system 100 allows one or more users to schedule appointments and/or view another user's schedule of appointments via a server 104 connected to the INTERNET 102. The users of the system 100 may communicate via one or more remote devices 106a-n (e.g., computers, personal digital assistants, web-enabled cellular telephones, etc.), and the server 104 receives and sends communications via an interface 108.

The server 104 contains a processor 110 (e.g., one or more conventional microprocessors) coupled to the interface 108. The server 104 further comprises computer program code 112 that allows the server 104 to receive communications from one or more users via one or more of the remote devices 106a-n. The communicates preferably may direct the server 104 (e.g., via appropriate computer program code 112) to:

1. generate an appointment schedule for a user (i.e., a schedulee);

2. allow the schedulee to set a password that prevents unauthorized users from viewing and/or modifying the schedulee's appointment schedule;

3. allow the entry of appointments into the schedulee's appointment schedule by authorized users (i.e., schedulers);

4. allow the schedulee and/or schedulers to view the schedulee's appointments;

5. notify the schedulee (e.g., via e-mail, telephone, facsimile, etc.) when an appointment has been entered;

6. reserve a conference room, a number of chairs, a white board, a projector or the like for an appointment;

7. display conference room availability;

8. automatically set up a telephone and/or video conference between the schedulee and one or more schedulers (e.g., by dialing the appropriate parties);

9. post an appointment agenda or exhibits for viewing by schedulers;

10. send an appointment agenda or exhibits to one or more schedulers (e.g., via e-mail, telephone, facsimile, etc.); and

11. allow a schedulee or scheduler to send broadcast e-mails to all parties scheduled for an appointment by sending an e-mail or some other message to the server 104.

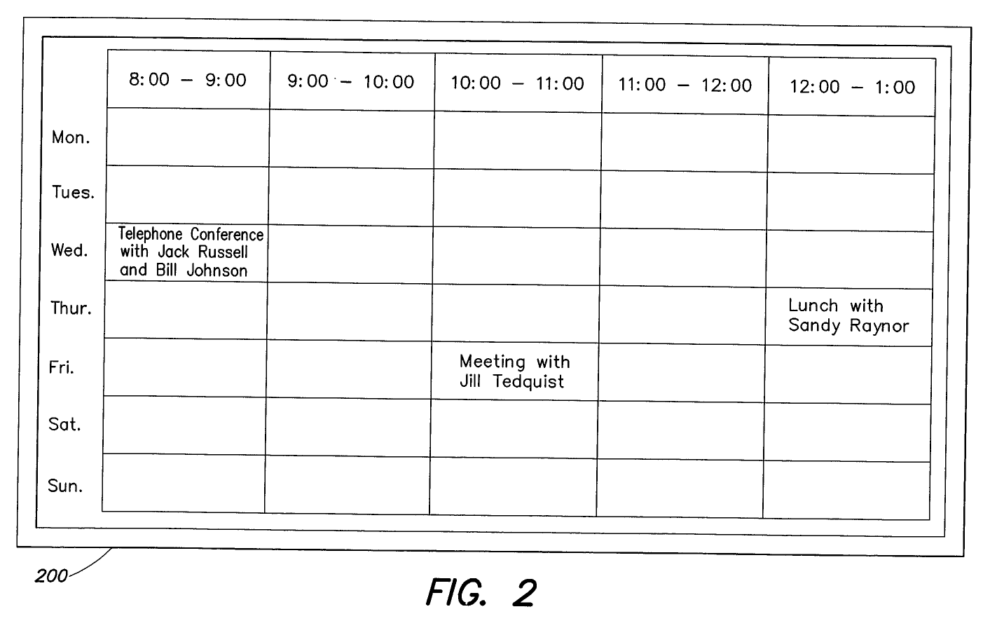

When a worldwide web-based interface such as a web-browser is employed, one or more of these operations may be performed via one or more HTTP transmissions to or from the server 104 and/or the remote devices 106a-n. HTTP transmissions are known in the art, and may comprise, for example, transmission via post commands. Preferably only one appointment can be scheduled for any given time period, and a priority code or password can be set that allows important schedulers (e.g., important clients, managers, etc.) to override less important schedulers. Overridden schedulers preferably are notified once overridden (e.g., via e-mail, telephone, facsimile, etc.). Other options that may be provided include allowing the schedulee to approve/override each entered appointment and/or notifying a scheduler when the scheduler's appointment is approved/overridden, sending an “updated” schedule to one or more schedulers when a new appointment is entered, allowing a scheduler to join another scheduler during an appointment, providing the schedulee and/or scheduler options to reserve a conference room, etc. FIG. 2 is an exemplary graphical user interface 200 that may be employed to schedule appointments in accordance with the present invention. Any other graphical user interface may be similarly employed.

The foregoing description discloses only exemplary embodiments of the invention, modifications of the above disclosed apparatus and method which fall within the scope of the invention will be readily apparent to those of ordinary skill in the art. For instance, the server 104 may be configured to communicate with one or more restaurants or caterers (e.g., via one or more of the remote devices 106a-n or one or more restaurant servers (not shown) that may communicate via the INTERNET 102). Person attending a scheduled appointment thereby may view one or more meal selections (e.g., one or more menus from one or more restaurants) and select a meal and/or a time for delivery of a meal. The server 104 may communicate such information to the appropriate restaurant and/or caterer.

Accordingly, while the present invention has been disclosed in connection with the preferred embodiments thereof, it should be understood that other embodiments may fall within the spirit and scope of the invention, as defined by the following claims.

The invention claimed is:

1. A server adapted to schedule appointments over the INTERNET comprising:
an interface adapted to send and to receive information regarding at least one appointment over the INTERNET; and
a processor coupled to the interface, the processor comprising computer program code adapted to schedule at least one appointment in response to information received via the interface.

2. The server of claim 1 wherein the processor further comprises computer program code adapted to generate an appointment schedule for a user.

3. The server of claim 2 wherein the processor further comprises computer program code adapted to allow a user to set a password that prevents unauthorized users from viewing or modifying the user's appointment schedule.

4. The server of claim 2 wherein the processor further comprises computer program code adapted to allow the entry of appointments into the user's appointment schedule by authorized users.

5. The server of claim 2 wherein the processor further comprises computer program code adapted to allow the user or one or more authorized users to view the user's appointments.

6. The server of claim 2 wherein the processor further comprises computer program code adapted to notify the user if an appointment has been entered.

7. The server of claim 2 wherein the processor further comprises computer program code adapted to reserve at least one of a conference room, a number of chairs, a white board and a projector for an appointment.

8. The server of claim 2 wherein the processor further comprises computer program code adapted to display conference room availability.

9. The server of claim 2 wherein the processor further comprises computer program code adapted to automatically set up a telephone or video conference between the user and one or more authorized users.

10. The server of claim 2 wherein the processor further comprises computer program code adapted to post an appointment agenda or exhibits for viewing by authorized users.

11. The server of claim 2 wherein the processor further comprises computer program code adapted to send an appointment agenda or exhibits to one or more authorized users.

12. The server of claim 2 wherein the processor further comprises computer program code adapted to allow the user or an authorized user to send broadcast e-mails to all parties scheduled for an appointment by sending a message to the server.

13. A computer-based method for scheduling an appointment comprising:
receiving via the INTERNET a request from a first user to view a schedule of a second user;
displaying via the INTERNET the schedule of the second user in response to the request;
receiving via the INTERNET a request from the first user to make an appointment with the second user; and
notifying the second user of the appointment via the INTERNET.

14. The method of claim 13 wherein each receiving step comprises receiving one or more HTTP transmissions.

15. The method of claim 13 wherein the displaying step and the notifying step comprise sending one or more HTTP transmissions.

16. A computer program product comprising:
a medium readable by a computer, the computer readable medium having program code adapted to:
receive via the INTERNET a request from a first user to view a schedule of a second user;
display via the INTERNET the schedule of the second user in response to the request;
receive via the INTERNET a request from the first user to make an appointment with the second user; and
notify the second user of the appointment via the INTERNET.
